(19) United States
(12) Patent Application Publication
(10) Pub. No.: US 2010/0276612 A1
(43) Pub. Date: Nov. 4, 2010

(54) TERAHERTZ EMITTERS

(76) Inventors: Robert A. Norwood, Tucson, AZ (US); Savas Tay, Tucson, AZ (US)

Correspondence Address: GREENLEE SULLIVAN P.C., 4875 PEARL EAST CIRCLE, SUITE 200, BOULDER, CO, 80301, US

(21) Appl. No.: 12/595,345

(22) PCT Filed: Apr. 11, 2008
(86) PCT No.: PCT/US08/59990

§ 371 Date: Jul. 26, 2010

Related U.S. Application Data
(60) Provisional application No. 60/923,343, filed on Apr. 13, 2007.

(51) Int. Cl. G21K 5/02

(52) U.S. Cl. 250/504 R

(57) ABSTRACT

A tunable radiation emitting structure comprising a discontinuous conducting interface having periodic or quasi-periodic features, wherein the structure emits narrowband terahertz radiation when heated is disclosed.

### CROSS-REFERENCE TO RELATED APPLICATIONS

This application claims priority to U.S. provisional application Ser. No. 60/923,343, filed Apr. 13, 2007, which is hereby incorporated by reference to the extent not inconsistent with the disclosure herewith.

### STATEMENT REGARDING FEDERAL RESEARCH SUPPORT

This invention was made with government support under Contract Number N00014-05-1-0303 awarded by Navy/ONR. The government has certain rights in the invention.

### BACKGROUND OF THE INVENTION

Electromagnetic waves that lie between the microwave and the low energy edge of the far-infrared parts of the spectrum are known as terahertz (“THz”) radiation. Terahertz radiation passes through materials and organic matter without the damaging ionizing effects produced by X-rays. In addition, THz waves interact with materials that involve weak bond vibrations and deformations, and therefore THz radiation has many potential uses in spectroscopy and imaging. THz radiation can be used, for example, to image and identify explosives concealed with other objects or buried underground. Using THz radiation it is possible to determine the identity of chemical or biological substances remotely without the need for physical contact, which makes these waves of critical importance for airport security applications.

Terahertz radiation is naturally emitted by hot objects (objects heated to above 10K), but the thermal emission is too weak (on the order or nanowatts) and the emission spectrum is too broad to be useful. Current THz radiation sources include quantum cascade lasers, gyrotrons, backward wave oscillators, synchrotron radiation, free-electron lasers or lasers that are based on optical mixing, all of which are relatively complex and cumbersome approaches. For example, a process to excite surface plasmons in metal films has been described, but requires a laser excitation source and sophisticated electronics and optics to generate the necessary pulse rate and duration (Welsh, Phys. Review. Lett. 98, 026803-1 (2007)). Other current approaches to generating THz radiation are complicated to fabricate. For example, U.S. Pat. No. 7,078,697 describes photonic crystal (or photonic band gap) structures that emit in the THz band under certain specified conditions.

There is a need in the art for an improved method for generating terahertz radiation.

### SUMMARY OF THE INVENTION

This invention generally provides emitters which are discontinuous conducting interfaces. In one embodiment, the emitters emit terahertz radiation. In one embodiment, the emitters emit radiation when heated. In one embodiment, the emitters emit radiation through coupled surface plasmons. The structures can be heated using any suitable means, such as application of electric field (Ohm heating) or radiative heating. Both the central wavelength of emission and bandwidth of emission can be tuned by appropriate selection of the distance between features and selection of the materials used. These parameters and their selection are further described below.

More specifically, provided is a tunable radiation emitting structure comprising: a discontinuous conducting interface having periodic or quasi-periodic features, wherein the structure emits narrowband terahertz radiation when heated. In separate embodiments, the interface is selected from the group consisting of: conductor/insulator; conductor/semiconductor; conductor/air, and conductor/conductor (providing the conductors have different dielectric properties). In one embodiment, a conductor is one or more metals. In one embodiment, a conductor is one or more transition metals. In one embodiment, a conductor is one or more platinum group metals. In one embodiment, a conductor is one or more of aluminum, platinum, gold, silver, copper, iron, iridium, tungsten, molybdenum, nickel, cobalt, zinc, lead, vanadium, chromium, and titanium. Silicon can also be used. As known in the art, more than one metals can be alloyed together. Such metal alloys may be used here. In one embodiment, an insulator is a polymer. Other examples of insulators are known in the art. In one embodiment, the interface contains nanoamorphous carbon having a total of from 0 to 60 wt percent of one or more metals.

In one embodiment, the center wavelength of emission is selected by changing the distance between features. In one embodiment, the center wavelength of emission is in the terahertz wavelength range. In one embodiment, the frequency of emission is between 0.3 THz and 10 THz. In one embodiment, the frequency of emission is between 0.3 and 1 THz. In one embodiment, the frequency of emission is between 1 and 3 THz. In one embodiment, the frequency of emission is between 3 and 5 THz. In one embodiment, the frequency of emission is between 5 and 7 THz. In one embodiment, the frequency of emission is between 7 and 10 THz. In one embodiment, the center wavelength of emission is between 30 μm (micrometer) to 1 mm (1000 micrometers). All individual values and ranges of emission wavelengths and frequencies in the terahertz wavelength and frequency ranges are intended to be included here, to the extent as if listed separately, for any purpose, including to exclude or include values or ranges in a claim.

The average distance between features is such that terahertz radiation is emitted from the structure under appropriate conditions for emission. In one embodiment, the average distance between features is from 30 micrometers to 1000 micrometers. In one embodiment, the average distance between features is between 100 micrometers and 500 micrometers. In one embodiment, the average distance between features is between 250 micrometers and 750 micrometers. As further described below, the emitted wavelength scales with the average distance between features, therefore, the desired emitted wavelength will affect the design distance between features. In one embodiment, the features form a photonic crystal structure. The preparation of photonic crystal structures is known in the art. In one embodiment, the width of the emission is selected by changing the difference in index of refraction in the interface materials. All individual values and ranges of distance between features are intended to be included here, to the extent as if listed separately, for any purpose, including to exclude or include values or ranges in a claim.

Also provided is a method of narrowband terahertz light emission, comprising: applying radiational energy to a structure described herein. The radiational energy takes any suitable form or temperature. In one embodiment, the radiational energy is heat. In one embodiment, the radiational energy is supplied by application of electric current. In one embodiment, the structure is heated to above 100° C. In one embodiment, the structure is heated to above 200° C. In one embodiment, the structure is heated to above 250° C. In one embodiment, the structure is heated to below the melting point of the structure. All temperature values and intermediate temperature ranges up to the melting point of the structure are intended to be included here to the extent as if they were individually listed, for any purpose, including to exclude or include values or ranges in a claim. In general, the intensity of emitted radiation increases with increasing temperature.

More specifically provided is a tunable radiation emitting structure comprising: a perforated or patterned conducting interface having a plurality of relief features provided in a periodic spatial configuration, wherein the relief features are separated from each other by adjacent recessed features, wherein the relief features are between 1 mm to 30 micrometers apart, and wherein the structure emits narrowband terahertz radiation when heated.

### BRIEF DESCRIPTION OF THE FIGURES

FIG. 1 shows an optical microscope image of a conducting (aluminum) film perforated with a hexagonal lattice of holes. The hole-to-hole distance is a and hole diameter is d.

FIG. 2 shows a side view of perforated (a) or surface patterned (b) conducting films. The hole-to-hole distance is a and hole diameter is d.

FIG. 3 shows radiation from a perforated conducting film (Silver/Silica/Silver) measured using an FTIR. The top silver film is perforated. The bottom and top curves show the spectra of the emitted radiation at 145 and 235° C., respectively. The broad curve shows emission from a non-perforated interface, which is a typical grey-body. Note that the location of the peaks do not change with the changing temperature, however, their intensity increases with increasing temperature. Similar results were obtained when metal (titanium nitride) doped nano-amorphous carbon films were used. The inset shows Emitted radiation in term of frequency.

FIG. 4 shows a THz emitter design employing a mirror (a thin metal film) for background suppression. (side view)

FIG. 5 shows another variant of the thermal THz emitter employing a 2D photonic crystal for enhancement of radiation. (side view)

FIG. 6 shows a conducting material that is discontinuated by introducing finite sized holes in a periodic array. Note that the holes do not reach to the bottom of the material. The sharp corners introduced on the top of the conducting material are sufficient to modify the SPP's to generate THZ radiation and suppress the background IR radiation. (side view)

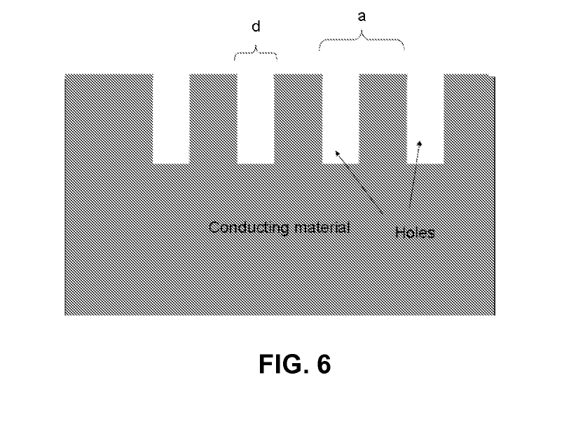

FIG. 7 shows an alternative geometry where a material that is not necessarily conductive but that allows easy fabrication of holes can be coated with a relatively thin layer (i.e. 0.5 micrometers) of a conducting material. Such a design generates THZ radiation by heating, as further described herein. (side view)

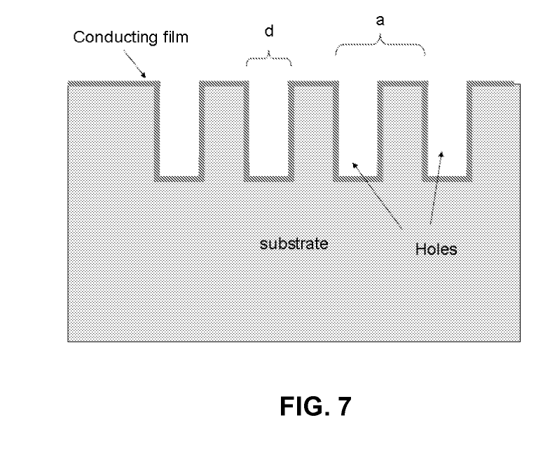

### DETAILED DESCRIPTION OF THE INVENTION

The term “electromagnetic radiation” and “light” are used synonymously in the present description and refer to waves of electric and magnetic fields. Electromagnetic radiation useful for the methods of the present invention includes infrared light.

As used herein, “terahertz radiation” is electromagnetic radiation having wavelength from 30 μm to 1 mm. THz radiation has frequency from about 300 GHz to about 10 THz. As is known in the art, the actual wavelength or frequency value may differ from that measured, depending on the limits of the measurement systems used. Therefore, wavelengths and frequencies with some variance from those given, such as ±5% are intended to be included. Emitters of the invention emit terahertz radiation when heated to an appropriate temperature. Emitters of the invention may also emit radiation in other portions of the electromagnetic spectrum. For example, emission frequencies higher than 10 THz (such as 10-60 THz) are possible using the teachings herein and an appropriate selection of parameters, as described herein. Also, emission frequencies lower than 0.3 THz are possible using the teachings herein and an appropriate selection of parameters, as described herein.

As used herein, “narrow band” means the bandwidth of the emitted peaks is smaller than blackbody radiation emitted at that temperature. Examples of narrow band emission include 1 micrometer FWHM (full width at half the maximum emission intensity), 3 micrometer FWHM; 5 micrometer FWHM; 10 micrometer FWHM; 15 micrometer FWHM; 25 micrometer FWHM; about half of the wavelength of emission; less than about half the wavelength of emission, and all intermediate values and ranges.

As used herein, a “discontinuous” surface contains periodic or quasi-periodic features. “Feature” refers to a three-dimensional structure or component of a structure. Features may be recessed in which they extend into a surface or may be relief features embossed or raised on a substrate surface. Features include, but are not limited to, holes, trenches, cavities, vias, channels, depressions, posts, slots, pits, stands, columns, ribbons or any combination of these. The term feature, as used herein, also refers to a pattern or an array of structures. The term feature, as used herein, encompasses a 1-D, 2-D or 3-D pattern, and encompasses patterns of nanostructures, patterns of microstructures, patterns of larger structures, or a pattern of microstructures and/or nanostructures and/or larger structures. Features may extend the depth of a layer or may have a height or depth that is a portion of a layer. Examples of discontinuous surfaces include “perforated” where there are features that extend the height of the surface or a layer thereof; and “patterned” where there are features that do not extend the height of a layer. Discontinuous surfaces are also formed when a layer generally follows a feature, such as a layer that is deposited or otherwise formed on a feature, even though the actual surface of the layer may be smooth.

As used herein, a “conducting interface” means two different materials, at least one of which conducts electricity, are in physical contact with each other. Examples of interfaces include one material (including air) filling the holes of another material; one material forming a layer on another material; a perforated or patterned material on top of a layer of another material; or one material following the contours of another material. Materials useful for conducting interfaces include conductor/insulator; conductor/semiconductor; conductor/air; and conductor/conductor (where the conductors have different conductivities). Physical contact does not necessarily mean there is continuous intimate contact, rather, there may be gaps in the contact, as long as the interface performs as described herein.

“Periodic” means that a structure or portion thereof has translational symmetry (or approximate translational symmetry). In one embodiment, periodic means that features are approximately (i.e., within ±10%) the same distance apart. Quasi-periodic means the structure is ordered, but not periodic. An ordering is nonperiodic if it lacks translational symmetry, which means that a shifted copy will never match exactly with its original. A structure may be periodic or quasi-periodic with the structure that is the closest in distance, or there may be a periodic or quasi-periodic arrangement in two dimensions with different structures, for example a surface may have intersecting patterns which each have periodic or quasi-periodic structures, but are not periodic or quasi-periodic if all structures are viewed together.

“Film” refers to a coating or layer of atoms, molecules or ions or mixtures and/or clusters thereof. Films in the present invention may comprise a single-layer having a substantially constant composition, a single-layer having a composition which varies as a function of physical thickness or a plurality of film layers. Film layers of the present invention include but are not limited to dielectric materials, metals, semiconductors, conducting materials, organic materials such as polymers and any combinations of these materials. In a preferred embodiment, reference to dielectric films in the present invention includes but is not limited to metal oxide, metalloid oxide and salt films. Film layers of the present invention may have any size, shape, physical thickness or optical thickness suitable for a selected application.

As used herein, “attach” does not necessarily mean a covalent bond is formed. Covalent or non-covalent interactions, such as hydrogen bonds, van der Waals interactions, ionic interactions, and other interactions may be formed when one structure attaches to another.

As used herein, “layer” does not necessarily mean that a complete layer is formed, but rather, defects or other areas of inconsistency may be found.

The discontinuous surface may have features that have any shape, such as round, oblong, square, rectangular, triangular, or irregular shaped, or a combination thereof. The shape of the feature is primarily dependent on the method used to form the feature, as known in the art. As used herein, a “square lattice” of relief features is an arrangement where four relief features form the vertexes of a square. The relief features themselves in a square lattice are not necessarily square; they may be circular, oval, square, rectangular, or any other convenient or desired shape. All arrangements of relief features, such as square lattice and other arrangements are included in the invention.

As used herein, “center wavelength of emission” is the wavelength (or small range of wavelengths, such as 10s of nanometers) where the emission intensity is the highest average intensity for a given emission spectrum.

The following nonlimiting description is intended to provide examples of some embodiments of this invention. Applicant does not intend to be bound by the theory presented here.

When a conducting interface is discontinuated, the main surface plasmon polariton modes of the interface are changed. Surface plasmon polaritons (SPP) are coupled modes of light and surface plasma waves and are responsible for extraordinary transmission through holes, filtering and narrow band emission/absorption of light. When a conducting surface that forms an interface with another material with different conductivity (such as a dielectric, another conducting film, or even air) is discontinuated with a periodic or quasi-periodic array of holes, with a hole-to-hole distance (for periodic structures) or average hole-to-hole distance (for quasi-periodic structures), a, ranging from a few millimeters to tens of micrometers, the thermal radiation from this device will consist of narrow band peaks in the THz regime, their wavelength being scalable with a, therefore providing a narrow-band thermally driven THz radiation source, an extraordinarily direct approach compared to other methods of generating THz radiation.

The periodic or quasi-periodic discontinuation of the interface is all that is required for a narrow band THz thermal radiation source. This structure emits THz radiation efficiently by simply heating it, given that a is within the range given herein.

The thickness of the discontinuated surface should be large enough to reflect back the unwanted thermal radiation coming from the background. This thickness should be on the order of or larger than of the skin depth of the background IR radiation at the given wavelength. The skin depth of electromagnetic radiation at a given wavelength for a conducting material is given by:

(λ/cπμσ)^{1/2}

where λ is the free space wavelength, c is the speed of light in vacuum, μ is the vacuum permeability and σ is the conductivity. The background may also be suppressed using other methods, such as a filter or mirror, for example, as known in the art and described further herein.

The diameter of holes or pattern can be selected based on the information provided herein, and the necessary fabrication process parameters and desired result. In general, the larger the diameter of the holes or pattern, the broader the bandwidth of the emitted radiation. As the holes or pattern become more narrow, the emitted radiation has less power compared to large holes.

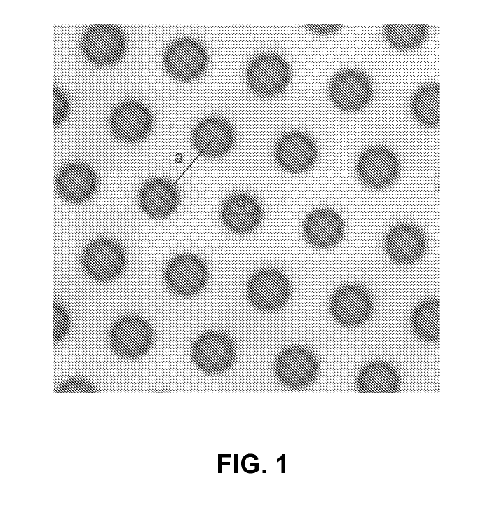

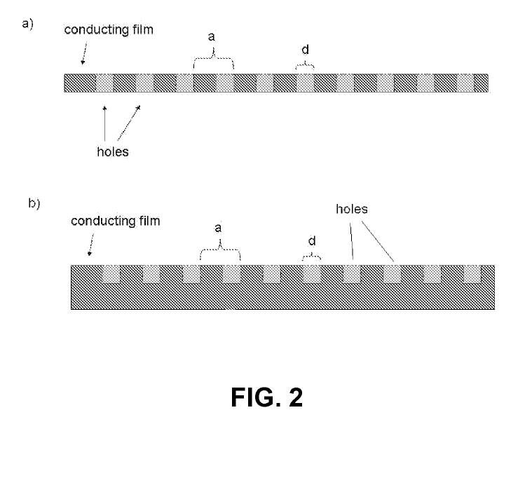

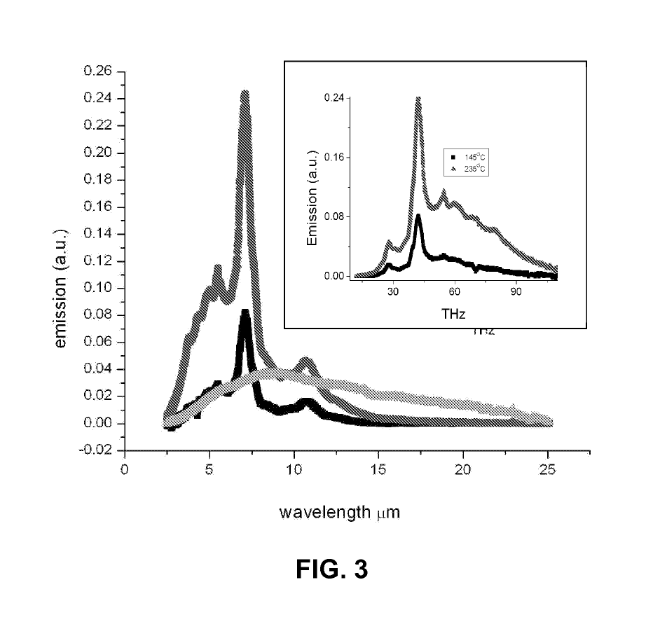

An example of such a THz radiation emitter is the structure shown in FIGS. 1 and 2. FIG. 1 is a top view of a conducting thin-film, i.e. a metal such as aluminum, or a metal doped composite such as nano-amorphous carbon, that is perforated with a periodic (or quasi-periodic) array of holes. FIG. 2 is a side view. The hole-to-hole distance, a, is the lattice period and d is the hole size. Such a conducting film can be heated by allowing an electrical current to pass through it or by simply placing it on a heated surface. When such a conducting film is heated, the thermal radiation emitted from the air/metal interface is significantly different from what would be emitted from a non-perforated conducting film. Such a heated, perforated conducting film emits narrow-band, THz radiation in a certain direction if the lattice constant is between a millimeter and a few tens of micrometers. Due to the modification of the surface plasmons and their coupling to the radiation modes via the grating (periodic array of holes), the perforated conducting film emits in a narrow spectrum at peak wavelengths close to the lattice period a (FIG. 3). Experiments reveal a bandwidth (FWHM) to wavelength ratio that is as small as 0.1 for such peaks. The locations of the emission peaks are independent of the temperature of the conducting film, and they can be tuned by changing the lattice constant or the dielectric constant of the conducting film. The spectral narrowing can be further adjusted by changing the index contrast between the surrounding dielectric and the metal. The wavelength of the emitted radiation is independent of the operating temperature. Due to the independence of the emission spectrum to temperature, these THz emitters can operate at very high temperatures, which in turn significantly increases the in-band power of the emitter.

The SPP mechanism results in emission peaks that are given by the equation below:

$$λ = {a ( \frac{4}{3} ( {i}^{2} + ij + {j}^{2} ) )}^{- 1 \text{/} 2} {( \frac{{ɛ}_{1} {ɛ}_{2}}{{ɛ}_{1} + {ɛ}_{2}} )}^{1 \text{/} 2}$$

Here, a is the lattice constant, ∈₁ and ∈₂ are the real part of the dielectric constant of the two materials that form the interface, i and j are indices (1, 2, 3 . . . ) that give the SPP mode number. For example, (1,0), and (0,1) and modes are degenerate and are emitted at the same wavelength. The higher modes (i,j>1) are usually much weaker in power.

As seen in the equation, the emitted wavelength is scalable with lattice constant a. So, for a conducting/dielectric interface, the emission peak can be tuned to the desired wavelength by changing a.

### Example 1

### Silver Emitter

In FIG. 3, data collected from an exemplary emitter device is shown. The emitter was fabricated by coating 100 nm silver, 200 nm silica and 100 nm silver on top of a silicon substrate. The top silver layer was perforated with a hexagonal lattice of holes with a=5 micron and d=2.5 microns. The data was collected using an FTIR spectrometer at different temperatures using a collection angle of 20 degrees normal to the emitter surface. The data shows strong emission around 7 micrometers (42.8 THz) with a bandwidth of ˜1 microns. Although the temperature was changed from 145 (bottom) degrees to 235 (top) degrees, the main emission peaks do not change their spectral positions. There is a secondary peak at 5.5 microns that corresponds to air/silver SPP's, and another weaker peak around 11 microns which is due to phononic modes of silica. With increased temperature, the in-band (7 micrometer) emission increases dramatically. The emission of a non-perforated interface at 235 degrees resembles a greybody with much less power in the desired in-band wavelengths, with a much broader bandwidth (bottom broad spectrum). This shows that the in-band emissivity of the perforated interface may exceed that of the inherent (greybody) emissivity of the un-perforated interface. The data shows a deviation of approximately 1 micrometer from the theoretically calculated value, which may be due to cross-coupling of top (air/silver) and bottom (silver/silica) SPP's.

If this structure was perforated with a=300 micrometers, and the thickness of the conducting films also scaled up accordingly so that transmission of the background IR radiation to the top is prevented (thick enough to achieve a reflectivity of 0% at the IR wavelengths), the peak emission would be around 420 microns when collected at normal incidence, which corresponds to emission at 0.71 THz, which is evident from direct extrapolation using the data at shorter wavelengths. This is due to the scaling of SPP resonances with the lattice constant as explained above. Note that fabrication of larger lattices and hole diameters is considerably simpler than smaller ones and therefore this technique does not require specialized fabrication processes.

The THz emitters based on perforated conducting interfaces can operate at any temperature as long as blackbody radiation at this temperature overlaps with the THz range. Objects with temperatures from 10° K. to thousands of K would emit greybody (emissivity less than 1) radiation which overlaps with THz range. The operational range for the emitters here are limited with the thermal damage threshold of the conducting interfaces. For example, metals tend to oxidize at temperatures above a 350° C. Thermally more stable materials such as metal doped diamond like carbon, nano-amorphous carbon or silicon carbide can be stable up to 1000° C. for extended periods and therefore can be used for fabricating THz emitters. In addition, protective coatings could be applied to the surfaces to prevent oxidization. Also, emitters can be packaged hermetically to prevent exposure to oxygen and moisture, which increases the useful temperature range.

Conducting thin-films and foils can be fabricated by a variety of methods such as thermal evaporation, CVD or variants of CVD such as PECVD, they can also be molded, or forged. The thickness of the perforated or patterned film can vary from a few nanometers to several millimeters, for example. As described elsewhere herein, the film should be thick enough to reflect back unwanted thermal radiation coming from the background. If the film becomes too thin, there may be increased background radiation, which would reduce the bandwidth in the THz range. The film may be as thick as desired, in accordance with the fabrication and other process variables, as known in the art. The perforation or patterning of the conducting film can be achieved with a variety of techniques including milling, laser drilling, metal injection molding, various etching techniques (wet etching, dry etching, plasma etching) or lift-off. The patterns to be transferred to the conducting film can be defined with lithography (photolithography, e-beam), holography, direct writing, molding or other patterning techniques. Metallic surfaces may be coated with dielectric or other protective coatings to prevent them from oxidization or other environmental effects. For example, the structure in FIG. 1 can be fabricated with the following steps:

Cleaning of the n-type silicon substrate (plasma cleaning, acetone, IPA and water rinsing);

Deposition of a 100 nm thick aluminum film on the substrate using thermal evaporation

Coating the aluminum film with photoresist using spin coating

UV exposure of the photoresist through a photomask that contains the array of holes

Development of holes using a developer

Etching of aluminum using wet etching, reactive ion etching or lift-off

Removal of photoresist using a plasma

This procedure can be modified to accommodate other substrates and deposition processes, as known in the art.

### Example 2

### Metal/Dielectric Emitter

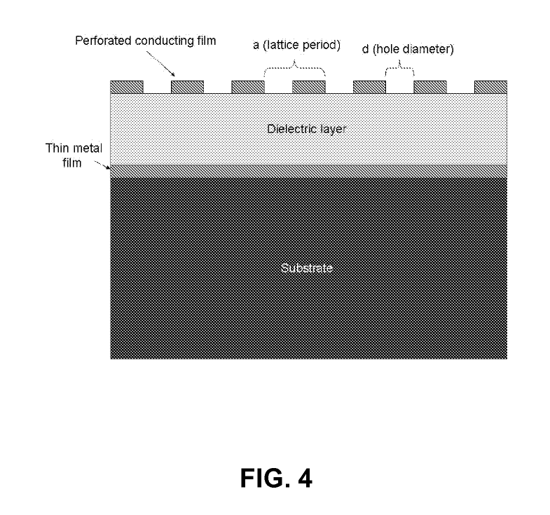

As mentioned above, a discontinuous conducting interface is necessary and sufficient for this narrow-band, tunable emission to occur. Additional layers can be used, if desired, for a given application. Another exemplary THz radiation source is constructed as follows: a substrate, such as a silicon wafer, is coated with a conducting thin-film. A dielectric layer is coated or grown on top of this film, on which another conducting film was coated. The top conducting film is then perforated with a periodic (or quasi-periodic) array of holes. Such a perforated surface is shown in FIG. 4. When heated, surface plasmon polaritons are induced in the (air/conducting film) and (conducting film/dielectric) interfaces. These SPP's will emit radiation in distinct narrow band peaks at wavelengths that are on the order of the lattice constant, a, similar to the single conducting film case described above. The dielectric layer between two conducting films may act as a source of blackbody radiation that may further increase the strength of SPP modes involved in narrow band emission. In this device, the number of peaks may increase since there are now two interfaces that generate SPP's at different frequencies. Some of these peaks may match and therefore increase the power emitted in a certain band. The lower, non-perforated conducting layer serves as mirror that reflects back the broad band blackbody radiation emitted by the thick substrate, therefore reducing the unwanted background in the forward direction. It may also help the narrow band emission to resonate between the two conducting layers and amplify the in-band THz radiation. It should be noted that this type of THz emitter is fundamentally no different than the structure shown in FIG. 1. In both structures, the main mechanism for efficient generation of narrow band THz radiation is the SPP's induced in the conducting interfaces.

### Example 3

### Conducting Film on Dielectric Substrate

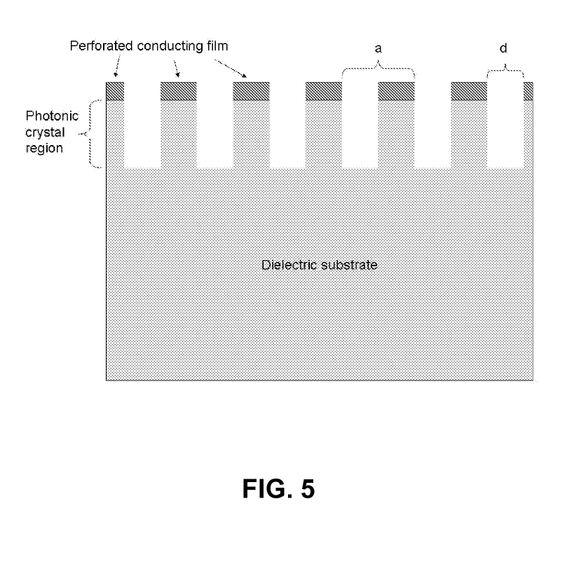

Another emitter configuration is shown in FIG. 5. Here, a conducting film is coated on a dielectric substrate. The holes extend deep into the substrate. A dielectric substrate patterned with a periodic array of holes may exhibit photonic stop-bands in certain direction, and if necessary conditions are matched, they can prevent the propagation of light in the plane of the substrate. Such devices that prevent propagation of certain frequencies of light in certain directions are known as photonic crystals (PC) or photonic band gap materials. If the substrate under the perforated conducting films is fabricated such that it forms a 2D photonic crystal, further enhancement of the in-band radiation may occur. The 2D photonic crystal results in an increase of the photonic density of states at the stop-bands. This means that radiation at wavelengths that match the stop band are efficiently stored in the PC. When they are coupled to the surface plasmons of the overlying perforated film, very efficient in-band emission is observed. When the stop-bands and lattice periodicity are matched and correspond to the THz radiation wavelength range, a thermally driven THz radiation source is realized. Note, however, the THz emission from this structure is based on the same mechanism with the previous two structures, that is SPP's induced in the conducting interfaces. The existence of the photonic crystal layer is not a requirement for narrowband, tunable emission to occur. The photonic crystal further enhances the radiation generated by the SPP's on the interface.

### REFERENCES

Lin, Applied Physics Letters 87, 173116 (2005); Williams, Nature Photonics 2, 175 (2008); US application 2007/0165295; Matsui, Nature 446, 517 (2007); US application 2007/0269178.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a structure is claimed, it should be understood that structures known in the prior art, including certain structures disclosed in the references disclosed herein (particularly in referenced patent documents), are not intended to be included in the claim.

When a group of substituents is disclosed herein, it is understood that all individual members of those groups and all subgroups of the group members, and classes of group members that can be formed using the substituents are disclosed separately. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds and other materials are intended to be exemplary, as it is known that one of ordinary skill in the art can name the same compounds and materials differently. One of ordinary skill in the art will appreciate that methods, device elements, starting materials, synthetic methods, and analysis methods other than those specifically exemplified can be employed in the practice of the invention without resort to undue experimentation. All art-known functional equivalents, of any such methods, device elements, starting materials, synthetic methods, and analysis methods are intended to be included in this invention. Whenever a range is given in the specification, for example, a thickness range, a distance range, a diameter range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a structure or in a description of elements of a device, is understood to encompass those structures and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The definitions are provided to clarify their specific use in the context of the invention.

We claim:

1. A tunable radiation emitting structure comprising:
a discontinuous conducting interface having periodic or quasi-periodic features, wherein the structure emits narrowband terahertz radiation.

2. The structure of claim 1, wherein the structure emits radiation when heated.

3. The structure of claim 1, wherein the average distance between features is from 30 micrometers to 1 mm.

4. The structure of claim 1, wherein the interface is selected from the group consisting of: conductor/insulator; conductor/semiconductor; conductor/air, and conductor/conductor.

5. The structure of claim 1, wherein a conductor is one or more metals.

6. The structure of claim 5, wherein a conductor is one or more transition metals or lanthanide metals.

7. The structure of claim 5, wherein one or more metals is selected from the group consisting of: aluminum, platinum, gold, silver, copper, iron, iridium, tungsten, molybdenum, nickel, cobalt, zinc, lead, vanadium, chromium, and titanium.

8. The structure of claim 1, wherein the interface comprises nanoamorphous carbon having a total of from 0 to 60 wt percent of one or more metals.

9. The structure of claim 1, wherein the center wavelength of emission is selected by changing the distance between features.

10. The structure of claim 1, wherein the center wavelength of emission is in the terahertz wavelength range.

11. The structure of claim 1, wherein the center wavelength of emission is between 30μ to 1 mm.

12. The structure of claim 1, wherein the features form a photonic crystal structure.

13. The structure of claim 1, wherein the width of the emission is selected by changing the difference in index of refraction between the interface materials.

14. A method of light emission, comprising:
applying radiational energy to a structure of claim 1.

15. The method of claim 14, wherein the radiational energy is heat.

16. The method of claim 14, wherein the radiational energy is supplied by application of electric current.

17. The method of claim 14, wherein the structure is heated to above 100° C.

18. The method of claim 14, wherein the structure is heated to below the melting point of the structure.

19. The method of claim 14, wherein the light is in the terahertz spectrum.

20. A tunable radiation emitting structure comprising:
a perforated or patterned metal film having a plurality of relief features provided in a periodic spatial configuration, wherein the relief features are separated from each other by adjacent recessed features, wherein the relief features are between 1 mm to 30 micrometers apart, and wherein the structure emits narrowband terahertz radiation when heated.
